(19) United States
(12) Patent Application Publication
(10) Pub. No.: US 2006/0187085 A1
(43) Pub. Date: Aug. 24, 2006

(54) Method for interchanging information data between an electrical load and an item of equipment, and a load recognition unit

(75) Inventors: Gerd Griepentrog, Gutenstetten (DE); Simon Huttinger, Erlangen (DE); Reinhard Maier, Herzogenaurach (DE); Martin Meyer, Nurnberg (DE); Hubert Schierling, Erlangen (DE); Richard Schmidt, Baiersdorf (DE)

Correspondence Address: Henry M. Feiereisen;Henry M. Feiereisen, LLC, Suite 4714, 350 Fifth Avenue, New York, NY, 10118, US

(73) Assignee: Siemens Aktiengesellschaft, Munchen (DE)

(21) Appl. No.: 11/355,492

(22) Filed: Feb. 16, 2006

(30) Foreign Application Priority Data
Feb. 22, 2005 (DE) 10 2005 008 050.2

(51) Int. Cl. G08C 15/06; G08B 23/00

(52) U.S. Cl. 340/870.02

(57) ABSTRACT

A method for interchanging information data between an electrical load and an item of equipment arranged between the load and the electric power grid is disclosed. An energy storage device located in a load recognition unit associated with the load is charged during a load recognition phase at start-up of the load. After the energy storage device is charged, data stored in the load recognition unit are repeatedly transmitted in form of a data burst to the item of equipment located between the load and the electric power grid. The data burst includes a preamble and load data; whereby the transmission is controlled by a controller in the load recognition unit.

### CROSS-REFERENCES TO RELATED APPLICATIONS

This application claims the priority of German Patent Application, Serial No. 10 2005 008 050.2, filed Feb. 22, 2005, pursuant to 35 U.S.C. 119(a)-(d), the content(s) of which is/are incorporated herein by reference.

### BACKGROUND OF THE INVENTION

The invention relates to a method for interchanging information data between an electrical load and an item of equipment arranged between the load and the electric power grid, and to a load recognition unit for carrying out the method.

The load contains a load recognition unit which comprises at least one equipment identification plate, which is stored in a storage means which can be read electronically. The load recognition unit is coupled to the power supply lines between the load and the electric power grid via a coupling impedance. The data from a transmitter in the load recognition unit, after initialization by the item of equipment, are modulated onto the voltage of the power supply lines, via the coupling impedance, by a carrier frequency which is higher than the system frequency.

The aforementioned loads can be electrical driving machines or other three-phase or single-phase loads, such as solenoid valves, switches etc. The items of equipment with which the loads are intended to communicate may be power converters, (AC power/three-phase AC power) actuators, electronic protection devices and similar devices for which the knowledge of data from the downstream loads is important.

It is known to provide electrical driving machines with a so-called equipment identification plate. For example, German Offenlegungsschrift DE 197 30 492 A1 describes storing information items on the driving machine, such as type information items or operation-starting information items, in a storage unit arranged in the driving machine. Thus, information items on the driving machine are automatically available by being read from the storage unit. The storage unit is integrated in the driving machine to be provided with a dedicated interface for the purpose of coupling an open-loop and/or closed-loop controller, in which case, however, an additional link, for example via a serial bus system, is required between the driving machine and the open-loop and/or closed-loop controller.

German Offenlegungsschrift DE 100 12 799 C2 discloses a three-phase motor, whose speed can be controlled during operation using a frequency converter, the motor having a memory module, in which the motor data relevant for the converter are stored. The converter includes an evaluation unit for reading the memory module. An additional signal line is also required to produce a communication link between the memory module in the motor and the data evaluation unit in the converter. Existing resolver signal lines are hereby used.

German Offenlegungsschrift DE 102 43 563 A1 proposes transmitting the information items from a driving machine to a controller (converter) or the like via a supply line used for the electrical power supply. It is thus intended to dispense with an additional dataline. Initialization of the data transmission takes place by means of the upstream controller likewise via the power supply lines, in which case, in particular, a zero-voltage state of the supply lines is used for data transmission. An electrical coil or a capacitive coupling between the conductors is used as the coupling unit.

In German Offenlegungsschrift DE 199 11 217 A1, the information items from a converter are modulated onto a power supply line at a higher frequency and are transmitted to at least one further converter, central computer or similar device.

It would be desirable to provide a method and a suitable load recognition unit for more securely and reliable transmitting information data between an electrical load and an item of equipment arranged between the load and the electric power grid.

### SUMMARY OF THE INVENTION

According to one aspect of the invention, a method for exchanging information data between an electric load and an item of equipment arranged between the load and an electric power grid includes the steps of charging, during a load recognition phase at start-up of the load, an energy storage device located in a load recognition unit associated with the load and, after the energy storage device is charged, repeatedly transmitting data stored in the load recognition unit in form of a data burst to the item of equipment located between the load and the electric power grid. The data burst includes a preamble and load data to be transmitted. The transmission is controlled by a controller in the load recognition unit.

In addition to the coupling impedance and the data storage element, for example an EEPROM, the load recognition unit also includes a power section and a control section, for example a microcontroller or a corresponding control logic. At the beginning of the load identification, initially the power section of the load recognition unit is charged (charging mode). After the charging mode, the load recognition unit transmits the stored data to the upstream item of equipment which requires the data, for example a converter, which is used to supply power to an electrical driving machine, whose data are transmitted to the converter. By adequately dimensioning the energy storage device in the power section, for example a capacitor, the microcontroller or the control logic, which forms the control section of the load recognition unit, transmits the data with a fixed number of repetitions or until there is no other signal on the lines (transmission mode) and as long as energy for data transmission is available.

The fact that there is no communication between the upstream item of equipment and the load markedly decreases costs, since only one transmitter and no communications receiver needs to be implemented in the load. To ensure a high degree of reliability for data transmission without the automatic repeat request protocol (ARQ), which cannot be implemented with unidirectional communication, the following protocol proposed in accordance with an preferred embodiment of the method:

The databurst is automatically repeated as long as power is available for the transmitter. In this case, the carrier frequency can be newly selected for each transmission attempt. Possible selection strategies may be as follows:
a set of fixed frequencies which are used successively.

For example, in the case of a pair of a driving machine and a converter, the coupling capacitance C_{K} is selected from the approximate knowledge of the leakage inductance from the rated motor power L_{M}=L_{1δ}+L′_{2δ}, such that an identical frequency fₘ is obtained for all motors, where the received voltage reaches a maximum at a minimum frequency. This frequency is fixed, for example, at fₘ=60 kHz. C_{K} is then:
C_{K}=1/4 JI²f²_{M}2L_{M}
the random selection of frequencies in a specific frequency range
the regulation to the current maximum in the transmission frequency range, i.e. successive increases in the frequency until the transmitted current reaches a maximum.

Alternatively, the frequency can also be scanned, i.e. successive increases in the frequency until the transmitted current reaches a maximum. However, this again requires an additional dataline for informing the transmitter that the maximum received voltage being reached. This dataline could, however, also be used for reading data in the load recognition unit.

The individual received sequences—even if they have been transmitted at different frequencies—can be combined directly with one another in the receiver (maximum ratio combining), since the same data contents are always transmitted (addition and correlation). This transmission method thus produces:
an increase in the signal-to-noise ratio (SNR), since each repetition is combined with the already received signal energy and thus the SNR increases with each repetition (different numbers of repetitions are required depending on the noisy environment until a telegram has been received with sufficient reliability. Provision should therefore be made for it to be possible for transmissions which were transmitted as a response to a plurality of charge bursts to also be combined in the receiver);
a variety of frequencies, since repetitions take place at different frequencies which may be subjected to other propagation conditions and interference;
time shifts, since the transmission including repetitions may extend over a relatively long period of time. Interferers which are active only at certain times merely extend the time until the communication is successful conclude, but do not prevent the communication.

Data transmission preferably takes place in the zero-voltage state of the power supply lines. Prior to this, initialization takes place by means of the upstream item of equipment, and the power section of the load recognition unit is charged. For example, a converter can be started for this purpose in a mode which still does not produce a voltage which would lead to startup of a driving machine. Then, a zero-voltage state is produced, in which data transmission takes place. Only when the load data are recognized as being error-free does the converter switch to normal operation.

The data can be secured in the following manner. Error-avoidance encoding (FEC=forward error correction) is not very expedient for the transmission protocol, since it considerably increases the complexity but achieves little effect compared to repetitions. Error-recognition encoding known per se. (checksum CRC=cyclical redundancy check, md4, md5=message digest algorithm) is therefore expediently used for securing the data in order that the receiver can ascertain when the transmission was successful.

It is particularly advantageous to select error-recognition encoding which is based on a cryptographic algorithm. In this case, the authenticity of the transmitted parameters can be verified. Any risk to humans or the system through operation with forged parameters can hence be effectively ruled out.

The databurst includes a preamble which may contain various information. The preamble should make it possible for the receiver, for example, to determine the transmission frequency. It can also be used for frame synchronization. In the case of transmission subject to severe interference or in the case of a poor SNR, it is difficult to clearly identify the beginning of a databurst by evaluating the preamble. However, this is important, since the signal-to-noise ratio should be improved by superimposing a plurality of identical databursts. A new databurst can then be identified by switching over to an alternative transmission frequency each time the transmission is repeated.

Since the carrier frequency can be determined at the receiver using the preamble, it is possible, to transmit further information by selecting the carrier frequency or the change in the carrier frequency. Possible applications for this could be as follows:
Signaling a change in the telegram contents:
When the carrier frequency is changed, the receiver begins the combination described in relation to the transmission protocol of successive telegrams anew. The method can therefore also function for telegrams having changing data contents.
Signaling a change in the telegram length: if the carrier frequency changes, the receiver begins the combination of successive telegrams anew. The method can therefore also function for telegrams having a changing length.
Signaling an (analog) measured value:
When the carrier frequency is selected so as to be proportional to a value measured in the load (for example motor temperature), this value can be determined in the receiver.

JI/4-DQPSK (DQPSK=differential quadrature phase shift keying) is advantageously selected as a modulation method. This method is easy to implement and is robust to interference, for example compared with FSK (FSK=frequency shift keying). In comparison with conventional QPSK, the bandwidth required is also slightly smaller, since there are zero crossings of the signal transitions in the baseband.

The coupling impedance, the power section and the control section including the storage means are designed such that they are not damaged during normal operation (normal mode).

To avoid complex equalization methods and, at the same time, to make high data rates possible, filtering can advantageously be carried out on the receiving item of equipment in order to shorten the pulse response of the channel and to allow high symbol rates with little intersymbol interference.

The coupling impedance can advantageously be divided into a plurality of elements to avoid overvoltages/flashovers.

The coupling impedance can advantageously be dimensioned to have high-pass characteristics which favors signal transmission during transmission operation.

An incoherent receiver can be selected as a simple variant. The incoherent receiver can be simplified to binary decisions by implementing delayed detection and represents a good compromise between complexity and performance.

Another possibility based a larger quantity of measurement results in actual environments is to simplify the receiver to reduce costs (reception by JI/4-DQPSK is also possible with a discriminator), or to increase the performance of the receiver by using a substantially more complex coherent detection.

Cooperation with other electronic equipment identification plates may be desired. In order to reduce the possibilities for errors and to avoid inconsistent data, electronic equipment identification plates for different reading devices are combined with each other or communicate with each other. If, for example, contactless reading of motor parameters in the vicinity of a motor is desired, the stored data could be transmitted via an additional RFID interface (radiofrequency. identification) and read using conventional reading devices.

Depending on the design, the load recognition unit can then include either
an additional passive RFID interface (for example motor data are in this case stored in the motor recognition unit), or
the load recognition unit acts as an RFID reading device and communicates with an RFID data carrier integrated in the load. In this case, the data are stored in the RFID data carrier. The load recognition unit reads these data and transmits the data over the power supply lines to the upstream item of equipment.

In order to reduce interference due to crosstalk, filters or capacitive circuitry may advantageously be arranged between the phases, thereby reducing the undesired signal components.

The load recognition unit can be installed already during the manufacture of a load unit, for example of an electric machine, and can be used to read out required individual components and assembly parts for automated manufacture.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows schematically an electrical driving machine with a rotation speed controllable by a converter, and

FIG. 2 shows the coupling of the power section of the motor recognition unit.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

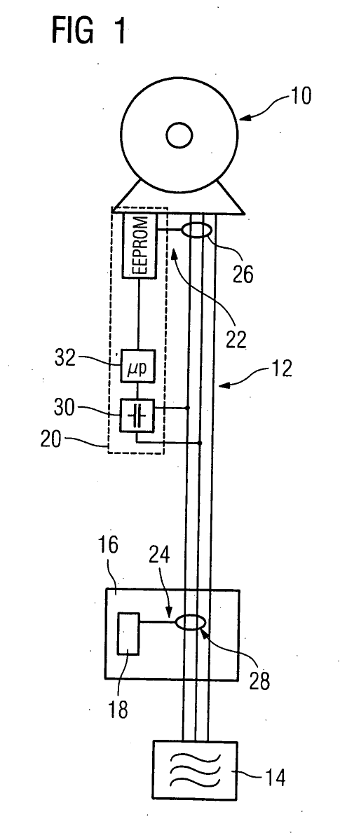

Turning now to the drawing, and in particular to FIG. 1, there is shown an electrical driving machine 10, for example a three-phase motor, as part of a drive with a changeable rotation speed. The driving machine 10 is connected to a power supply system 14 via a supply line 12 used for supplying electrical power. A converter 16, which is used for changing the frequency of the system frequency of the power supply system 14 to a drive frequency of the driving machine 10, is arranged upstream of the driving machine 10. The converter 16 is controlled by a controller 18.

The design and operation of an electrical driving machine operated via a converter on a power supply system are generally known and will not be described in details in the context of the present description.

To start operation of the drive unit, the converter 16 is parameterized with respect to the driving machine 10. For this purpose, specific motor data of the driving machine 10 need to be input to the controller 18. These motor data are stored in a motor recognition unit 20 in an electronically readable form, the motor recognition unit 20 containing a storage means, customarily an EEPROM, for this purpose. These information data contain, for example, equivalent circuit data for the driving machine 10, performance parameters for the driving machine 10, the order number of the driving machine 10, type designations of the driving machine 10 or the like.

Both the motor recognition unit 20 and the controller 18 are coupled to the supply line 12 via a respective coupling impedance 22 or 24. The coupling impedances 22 and 24 include, inter alia, an electromagnetic coil 26 and 28, respectively, which are each assigned to at least one phase of the supply line 12.

Coupling can also take place via capacitors or in wireless fashion via antennas arranged close to the supply line 12.

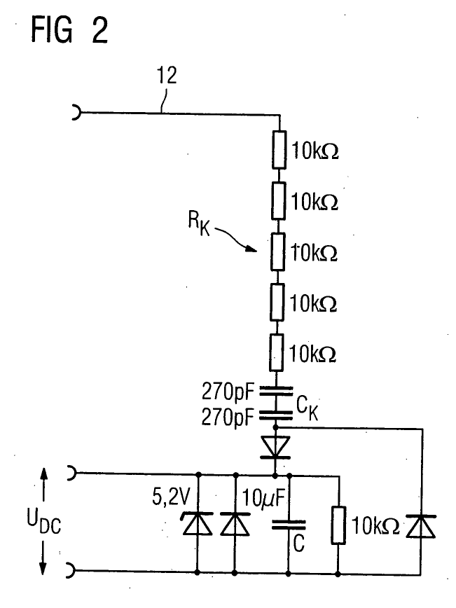

FIG. 2 shows an energy storage device 30 of the motor recognition unit. The energy storage device includes a charging capacitor C=100 pF and is coupled to two phases of the motor supply line 12 by a dedicated coupling impedance, a two-port network, by an RC series circuit with R_{K}=5×10 kΩ and C_{K}=2×270 pF.

To control the data transmission, a control section 32 is provided in the motor recognition unit 20, and the control section 32 can be implemented by a microprocessor.

To start operation of the drive unit, the charging capacitor C is initially charged by the converter 16 via two phases (lines) with a burst at full voltage (±560 V). Once the charging capacitor C is charged, read-out of the information data from the motor recognition unit 20 can be initiated by the control section 32. Read-out takes place via the coupling impedance 22.

The coupling impedance 22 needs to be dimensioned to satisfy three requirements, which can sometimes be contradictory:
charging mode: sufficiently low impedance for rapid charging;
transmission mode: sufficiently low impedance for achieving a sufficiently high signal level on the power supply lines so that the received signal can be adequately extracted from interference;
normal mode: sufficiently high impedance for protecting the motor recognition unit and to minimize power loss at the coupling impedance.

The data are transmitted through modulation onto a carrier frequency in a databurst which includes a preamble and the actual data. The preamble makes transmission possible at any desired carrier frequency, for example in the range between 15 kHz and 100 kHz. The carrier frequency does not need to be known to the receiver in advance.

The duration of this databurst, during which only the few bytes of motor recognition are transmitted, can be in a range of several 100 ms.

The data are filtered at the receiver (at the converter 16) to shorten the pulse response of the transmission channel and enable high symbol rates with little intersymbol interference. An exemplary first-order RC bandpass (center frequency at 50 kHz, 3 dB cut-off frequency 15 kHz) shortens the pulse response of the transmission channel (50 m motor cable, 6 A three-phase motor) to less than 200 μs.

The transmission is automatically repeated as long as the charge voltage of the charging capacitor C allows, wherein the carrier frequency is newly selected within the aforementioned range for each new transmission. The converter 16 switches into the start-up mode for the driving machine 10 only when the data are recognized as being error-free.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for exchanging information data between an electric load and an item of equipment arranged between the load and an electric power grid, comprising
during a load recognition phase at start-up of the load, charging an energy storage device located in a load recognition unit associated with the load, and
after the energy storage device is charged, repeatedly transmitting data stored in the load recognition unit in form of a data burst to the item of equipment located between the load and the electric power grid, the data burst comprising a preamble and load data to be transmitted;
wherein the transmission is controlled by a controller in the load recognition unit.

2. The method of claim 1, wherein the load recognition unit includes at least one electronically readable equipment identification plate.

3. The method of claim 1, wherein the data are modulated onto a carrier with a carrier frequency which is transmitted over power supply lines.

4. The method of claim 3, wherein the carrier frequency is higher than a frequency of the electric power grid.

5. The method of claim 3, wherein the carrier frequency is fixed and selected such that a received voltage reaches a maximum.

6. The method of claim 3, wherein the carrier frequency is increased by the controller of the load recognition unit until a transmitted current reaches a maximum.

7. The method of claim 3, wherein the carrier frequency is increased by scanning the carrier frequency until a received voltage reaches a maximum.

8. The method of claim 1, wherein the data burst is repetitively transmitted as long as the charge of the energy storage device is sufficient to allow data transmission.

9. The method of claim 3, wherein the carrier frequency is reset after each data transmission.

10. The method of claim 1, wherein the data are encoded.

11. The method of claim 10, wherein the data are encoded by using an encryption algorithm.

12. The method of claim 3, wherein the preamble of the data burst includes information about a level of the carrier frequency.

13. The method of claim 12, wherein the frequency of the carrier or a change in the frequency of the carrier are used for transmitting additional information.

14. A load recognition unit for an electric load, comprising:
an electronically readable storage means;
at least one equipment identification plate stored in the storage means;
an item of equipment located upstream of the electric load;
a transmitter associated with the load, said transmitter after initialization by the item of equipment transmitting data via a carrier frequency signal to the item of equipment; and
a dedicated energy storage device and a dedicated controller which causes the transmitter to transmit the data repeatedly.

15. The load recognition unit of claim 14, wherein the transmitter transmits the data via at least one coupling impedance and a power supply line connecting the load and the item of equipment.

16. The load recognition unit of claim 14, wherein the energy storage device comprises is a charging capacitor.

17. The load recognition unit of claim 14, wherein the controller comprises a microcontroller.

18. The load recognition unit of claim 14, wherein the controller comprises a logic circuit.

19. The load recognition unit of claim 14, wherein the energy storage device has a dedicated coupling impedance.

20. The load recognition unit of claim 14, wherein the storage means is a nonvolatile data storage element.

21. The load recognition unit of claim 14, further comprising an RFID (radio-frequency-identification) interface.
